(19) United States
(12) Patent Application Publication
(10) Pub. No.: US 2015/0329340 A1
(43) Pub. Date: Nov. 19, 2015

(54) Mobile unit for bottling wine

(71) Applicant: Daniele Ferasin, Vo' (PD) (IT)

(72) Inventor: Daniele Ferasin, Vo' (PD) (IT)

(21) Appl. No.: 14/650,109

(22) PCT Filed: Oct. 17, 2013
(86) PCT No.: PCT/IB2013/059416

§ 371 Date: Jun. 5, 2015

(30) Foreign Application Priority Data
Oct. 18, 2012 (IT) PD2012A000304

(51) Int. Cl. B67C 3/00; B65B 55/24; B65B 61/26; B65C 3/06

(52) U.S. Cl. CPC B67C 3/008; B65C 3/06; B65B 55/24; B65B 61/26

(57) ABSTRACT

A mobile wine bottling unit includes, among its main parts, a partially closed roll-off case with a compartment, inside which there is bottling equipment: a feeding system for the product to be bottled, a hydraulic connection to a water system, an electric connection to the company's electricity network, a collecting system for bottles to be filled in succession and for conveying them, a station for washing the inside of a bottle, a filling station, a corking/capping station, a capsuling station, a bottle drying station, and a labeling machine.

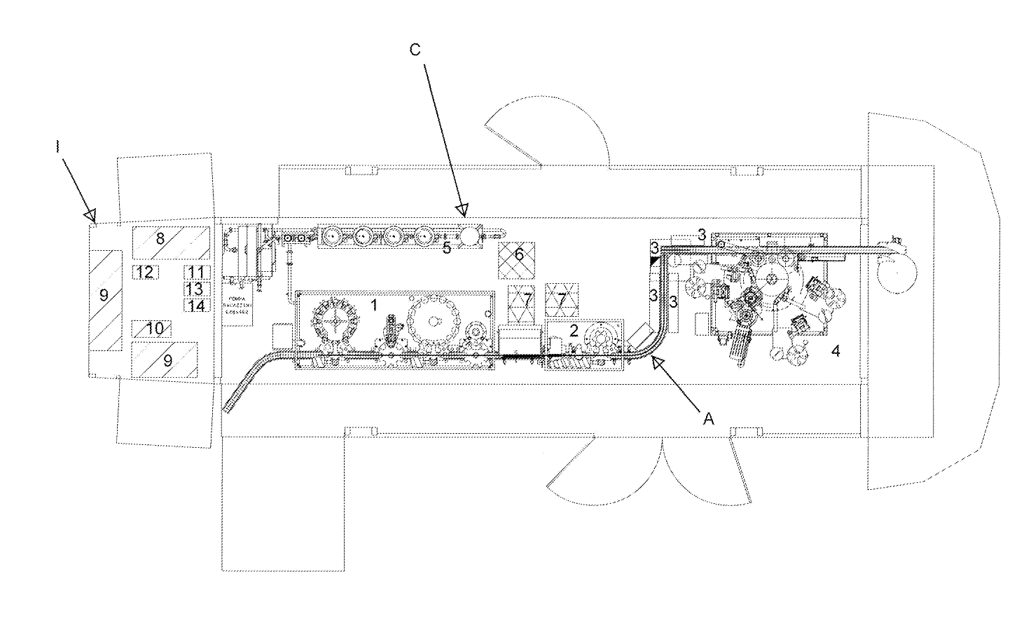

The present patent concerns the equipment for bottling wine, and in particular it concerns a new mobile unit for bottling wine.

Mobile units for bottling wine are known, meaning structures that are loaded on, towed by or mounted on tractors, and comprising various stations where the wine bottling and bottle packaging steps are carried out.

Said mobile bottling units are suited to provide bottling and packaging services to wineries/winemakers at their premises.

Mobile units generally comprise a roll-off case inside which there is the equipment for bottling and packaging. Said structure comprises also means for connection to the company's electricity network, for feeding the product to be bottled and for supplying the water necessary for the washing operations.

The mobile bottling units of the known type generally comprise various stations that operate in succession and in a coordinated manner.

The mobile units comprise a system for softening and filtering the water needed for the various operations, and at least one rinsing machine suited to rinse the inside of the bottles in order to remove any impurities, glass fragments, insects, etc.

Downstream of the rinsing machine, the moving units comprise a filling machine, with devices suited to collect wine and introduce it into the bottles. Filling machines of various types are known, suitable for the different types of wine to be bottled, for example gravity filling machines, vacuum or non vacuum filling machines and isobaric filling machines for bottling semi-sparkling and sparkling wines.

Downstream of the filling machine, the moving bottling units comprise a corking/capping machine for closing the bottle, using synthetic plugs or corks (flush plug) and metallic caps (screw caps), said corking/capping machine being located downstream of said filling machine.

Downstream of the corking/capping machine there is a capsuling machine for the application of metal or plastic capsules, said capsuling machine being located downstream of said corking/capping machine.

Downstream of the capsuling machine, the mobile units comprise at least one labelling machine for the application of one or more labels to the body of the bottle, for example a front label, a rear label, a neck label, a strip, etc. Mobile units are known that comprise printing stations, comprising printers suited to print the batch number or other information on the bottle.

In the production chain using mobile units of the known type the mobile unit is delivered to the winery that ordered it and is positioned at approximately 20-30 cm from the ground.

Before starting the bottling operations, the mobile unit is first connected to the various utilities, and the filters, the pipes and the filling machine are sanitized.

The instruments and the various pieces of equipment are then set.

The actual bottling cycle starts with the intake of the product to be bottled through pumping systems. The bottles are first rinsed inside the rinsing machine, then filled with the filling machine and finally corked/capped with the corking/capping machine.

The labelling step is performed at the end of the bottling step.

On the other hand, the filling and handling of the boxes or cartons containing the bottles that are leaving the bottling line are performed at ground level by the personnel of the company that ordered the bottling unit. A drawback posed by the mobile units of the known type lies in that after the bottling step several parts of the bottle are humid and/or wet and therefore the bottle is not ready for the packaging step.

The subject of the present patent is a new type of mobile wine bottling unit that:
is capable of drying said bottles thanks to two intrinsic details, the bottling line in the shape of an “S” downstream of the capsuling machine and a blowing step performed on the bottle while it moves along the S-shaped section;
has all the connections to the main utilities (electricity, mains water, hot and cold water, air production) grouped in a top front compartment.

The main object of the present invention is to provide a system for packaging the bottles in the best possible way, with optimal results even in adverse climatic conditions (cold wines in particularly humid and hot days, days with high humidity, rainy days), which can make the work of the technical personnel much more comfortable and organized, thanks to the design of the top front compartment.

These and other direct and complementary objects are achieved by the new mobile wine bottling unit, whose main parts include:
a case suited to be towed by or mounted on a trailer, and driven by a tractor, defining at least one compartment inside which there is the bottling equipment, said case being provided with a top front compartment, meaning a compartment that can be accessed from the inside, integral with said closed case and positioned on the top front part of the cab, said top front compartment housing a pressure washer, an air compressor, an air dryer, a softener for the water coming from the water mains, winding units for the 400V and 230 V electric cables connected to the company's electricity network, a winding unit for the pipe containing the water delivered by the company's network and a winding unit for the high-pressure water pipe of the pressure washer.

Said case comprises:
means for feeding the product to be bottled;
means for collecting the bottles to be filled in succession and for conveying them to at least one first washing and/or rinsing station;
said at least one rinsing station or rinsing machine for the bottle rinsing operation;
at least one filling station or filling machine, provided with devices suited to collect the wine and introduce it in succession into one or more bottles, said filling machine being located downstream of said rinsing machine;
at least one corking/capping machine suited to cork/cap the bottles either with a syntethic plug or cork (flush plug) or with a metal cap (screw cap), said corking/capping machine being located downstream of said filling machine;
at least one capsuling machine for the application of metal or plastic capsules, said capsuling machine being located downstream of said corking/capping machine;
at least one drying station for drying the outside of the bottles, located on the S-shaped section of the bottling line, said drying station being located downstream of said capsuling machine;
at least one labelling machine for the application of one or more labels to the body of the bottle, for example a front label, a rear label, a neck label, a strip etc., said labelling machine being located downstream of said washing station and of said drying station.

The bottle conveyor line comprises, between the capsuling machine and the labelling machine, an S-shaped curve intended to increase the distance covered by the bottles during the drying step performed with the dryer.

According to the invention, the new mobile unit comprises also at least one system for softening and filtering the water used to wash the bottles.

According to the invention, the new mobile unit may also comprise a printing station, provided with a printer suited to print the batch number or other information on the bottle.

The characteristics of the new mobile unit are highlighted in greater detail in the following description with reference to the drawing attached by way of non-limiting example.

The mobile unit comprises a partially closed roll-off case (C) suited to be driven by a tractor, defining at least one partially closed compartment inside which there are the bottling equipment and a top front compartment (I) containing the accessory equipment, said top front compartment being integral with the front part of the roll-off case and being positioned on the roof of the tractor during transport on roads.

Said mobile unit (C) comprises means for feeding the product to be bottled (5) and for the hydraulic connection to the water supply network.

Said mobile unit (C) furthermore comprises means (1) for collecting the bottles to be filled in succession and conveying them to at least one first washing station and/or rinsing station or rinsing machine.

Downstream of said rinsing machine (1), said mobile unit with roll-off case (C) comprises, in the given order, at least one filling station or filling machine, at least one corking/capping machine (1), at least one capsuling machine (2), at least one station for drying the outside of the bottles (3), said drying station being located downstream of said capsuling machine (2), and at least one labelling machine (4).

Along the bottle conveyor line, between the capsuling machine (2) and the drying machine (3), there is a curved section (A) intended to increase the time needed by the bottles to complete their route and to favour the drying operation, even with the aid of forced air.

The top front compartment (I) contains the accessory equipment such as the pressure washer (8), the compressor-air dryer (9), the water softener (10), a winding unit for the mains water pipe (11), a winding unit for the high-pressure water pipe (12), winding units for the electric cables (13, 14).

Other devices like a nitrogen generator (7) and a cork/cap lifting device (6) are positioned inside the roll-off case (C).

Therefore, with reference to the above description and the attached drawing, the following claims are expressed.

The invention claimed is:

1. A mobile unit (C) for bottling wine, comprising:
a roll-off case (C) defining at least one compartment and configured to be driven by a tractor, wherein inside said compartment there is bottling equipment, said bottling equipment comprising:
a bottle conveyor line;
a feeding system for a the product to be bottled (5) and for a hydraulic connection system to a water mains;
a collecting system for bottles to be filled in succession and for conveying the bottles to at least one of a first washing or rinsing station or rinsing machine;
said at least one of a washing or rinsing station or rinsing machine (1) for rinsing one or more bottles in succession;
at least one filling station or filling machine (1), provided with devices suited to draw wine (5) and introduce the wine into one or more bottles in succession, said filling station or machine being located downstream of said washing or rinsing machine;
at least one corking/capping machine (1) configured to plug a bottle with a flush cork, plug, or a screw cap and located downstream of said filling station or machine;
at least one capsuling machine (2) configured to apply metal or plastic capsules, said capsuling machine being located downstream of said corking/capping machine;
at least one station (3), downstream of said capsuling machine, where an outer surface of the bottle is dried in order to eliminate any condensation or water drops present after bottling, comprising forced air devices; and
at least one labelling machine (4) configured to apply one or more labels to a body of the bottle, said labelling machine being located downstream of said capsuling machine.

2. The mobile bottling unit according to claim 1, wherein said roll-off case (C) comprises a compartment that can be accessed from outside, is integral with said roll-off case and is positioned frontally on top of a driver's cab.

3. The mobile bottling unit according to claim 2, wherein said compartment (I) houses one or more pieces of accessory equipment selected from the group consisting of a pressure washer (8), a compressor-drier with compressed air tank (9), a winding unit for high-pressure water pipes (12), a winding unit for pipes that convey water to the bottling unit from a company's water system (11), and two winding units for electric cables, respectively for 400V (13) and 230V (14).

4. The mobile bottling unit according to claim 1, wherein the bottle conveyor line comprises, between the capsuling machine (2) and the labelling machine (4), one or more curves (A) intended to extend a route of the bottles before and/or during drying of the bottle drying step performed with the drying station (3).

5. The mobile bottling unit according to claim 1, further comprising at least one station (3) for drying the outer surfaces of the bottles, said drying station (3) being located downstream of said capsuling machine (2) and upstream of said labelling machine (4).

6. The mobile bottling unit according claim 1, wherein said corking/capping machine is combined with said at least one capsuling machine (2).

7. The mobile bottling unit according to claim 1, further comprising a nitrogen generator (7) positioned inside the roll-off case (C).

8. The mobile bottling unit according to claim 1, further comprising at least one cork/cap lifting device (6) positioned inside the roll-off case (C).

9. The mobile bottling unit according to claim 1, further comprising a system (10) for softening and filtering water coming from the water mains.

10. The mobile bottling unit according to claim 1, further comprising one or more printing stations comprising a printer configured to print a batch number or other information on the bottle.
